(19) United States
(12) Patent Application Publication
(10) Pub. No.: US 2018/0346739 A1
(43) Pub. Date: Dec. 6, 2018

(54) POLYMERIC FLAME RETARDANT MIXTURES

(71) Applicant: CLARIANT PLASTICS & COATINGS LTD, Muttenz (CH)

(72) Inventors: Harald BAUER, Kerpen (DE); Sebastian HÖROLD, Diedorf (DE); Martin SICKEN, Köln (DE); Michael DYBALLA, Frankfurt (DE); Mike SAHL, Bad Camberg (DE); Karl-Heinz SCHWEIKART, Eppstein-Bremthal (DE)

(73) Assignee: CLARIANT PLASTICS & COATINGS LTD, Muttenz (CH)

(21) Appl. No.: 15/778,123

(22) PCT Filed: Nov. 21, 2016
(86) PCT No.: PCT/EP2016/078288

§ 371 Date: May 22, 2018

(30) Foreign Application Priority Data
Nov. 26, 2015 (DE) 10 2015 223 432.0

(51) Int. Cl. C09D 5/18; C09D 177/02

(52) U.S. Cl. CPC C09D 5/185; C08K 5/5313; C09D 177/02

(57) ABSTRACT

The invention relates to polymeric flame retardant mixtures containing a) 0.1 to 70 wt % dialkyl phosphinic acid salt, b) 0 to 20 wt % telomers, and c) 30 to 99.9 wt % oligomers, a), b) and c) adding up to 100 wt %, with the proviso that a), b) and c) are different compounds. The invention also relates to methods for synthesizing said polymeric flame retardant mixtures and the use thereof.

The invention relates to polymeric flame retardant mixtures, to a process for production thereof and to the use thereof, especially in flame-retardant fiber and film polymer molding compounds.

According to the prior art, pulverulent dialkylphosphinic salts are used alone or together with other agents, preferably in flame retardant mixtures for polymers.

Dialkylphosphinic salts are used in compositions comprising polybutylene terephthalate and polyethylene terephthalate in construction materials for electronics (WO-A-2013/165007). The polyethylene terephthalate here has been modified with lactone components. However, the dialkylphosphinic salt particles used themselves are too coarse and would result in blockages and surface defects in fibers and films.

There has therefore been no lack of attempts to convert coarser particles of pulverulent flame retardants to the desired small size by wet grinding in a solvent. In many cases, however, this process is not implementable or does not lead to the desired particle sizes.

An unavoidable drawback of grinding in a solvent is the removal of the solvent prior to incorporation into a fiber or film polymer molding compound to be rendered flame-retardant. This is uneconomic and a matter of safety concern, since many solvents are inflammable and there is the risk of reagglomeration. The direct incorporation of a flame retardant suspended in solvent into a molten spun polymer is difficult from a safety point of view because the solvent would evaporate and form an explosive atmosphere.

For instance, JP-B-5129018 describes how dialkylphosphinic salts can be incorporated into polyphenylene ether polymers (PPE) in nanoparticulate form by means of wet grinding in a solvent, where the typical problems with wet grinding can occur. In addition, methanol, the solvent preferred in JP-B-5129018, is inflammable and, owing to its toxicity, a very high level of safety measures is needed, and so the process is of poor usability from an economic point of view. Moreover, PPE is not usable for fibers.

In fiber spinning or film blowing, very fine particles are required. Excessively coarse (flame retardant) particles lead to blockages in the nozzles and melt filters in fiber spinning or film blowing. They lead to fiber breakoffs where they take up considerable portions of the fiber cross section and there is no polymer present. Excessively coarse particles can cause surface irregularities (e.g. elevations that impair film and fiber smoothness).

It is difficult to keep finely divided (additive, non-polymeric) flame retardants in finely divided form in a homogeneous and lasting manner from the start and during the further processing operations. There may be reagglomeration of the particles, where they become too large and/or too coarse again. This effect can be reduced by additions, but these impair the fiber and film properties because of their proportion and can have adverse chemical interactions with the fiber and film constituents.

It is therefore an object of the present invention to provide polymeric flame retardant mixtures which easily enable processing to give fibers and films and in which the flame retardant is thus sufficiently finely distributed in sufficiently small particle size.

The polymeric flame retardants should be incorporable into the non-flame-retardant polymer directly prior to the spinning or film blowing step (called “additive flame retardants”), without any occurrence of an increase in size or coarsening of the particles.

By contrast, in the case of polymers that have flame-retardant molecular moieties firmly incorporated in their polymer chain (and hence are inherently flame-retardant), the flame retardant concentration and hence the strength of the flame retardancy cannot be adjusted in a variable manner, which leads to production-related drawbacks.

It is a further object of the invention to provide halogen-free polymeric flame retardant mixtures and halogen-free flame-retardant fiber and film molding compounds, since halogenated products of the aforementioned type can have drawbacks for the environment as a result of dioxin formation in the incineration of waste or accumulation in the food chain. In principle, halogenated products should be avoided for many fields of application, especially the use of halogenated flame retardants, owing to their many known drawbacks.

It is a further object of the present invention to provide a process in which the flame retardant can be incorporated into the spun polymer without any problem, the flame retardant is optimally dispersed and then, in small particle size in the polymer, exhibits its effect with good flame retardancy properties.

The flame retardants used shall impair the fiber properties to a minimum degree.

The object stated at the outset is achieved by polymeric flame retardant mixtures comprising

a) 0.1% to 70% by weight of dialkylphosphinic salt,

b) 0% to 20% by weight of telomers and

c) 30% to 99.9% by weight of oligomers,

where the sum total of a), b) and c) is 100% by weight, with the proviso that a) and

b) are different compounds.

Preferably, the polymeric flame retardant mixtures comprise

a) 2% to 50% by weight of dialkylphosphinic salt,

b) 0.1% to 10% by weight of telomers and

c) 50% to 97.9% by weight of oligomers,

where the sum total of a), b) and c) is 100% by weight, with the proviso that a) and

b) are different compounds.

The dialkylphosphinic salts are preferably those of the formula (V)

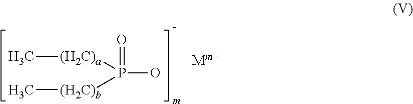

in which
a and b may be the same or different and are each independently 1 to 9, and where the carbon chains may be linear, branched or cyclic, and
M is Mg, Ca, Al, Sb, Sn, Ge, Ti, Fe, Zr, Zn, Ce, Bi, Sr, Mn, Li, Na, K and/or a protonated nitrogen base and
m is 1 to 4.

Preferably, a and b in formula (V) are the same or different and may each independently be 1, 2 or 3.

Preferably, a and b in formula (V) are the same and are each 1.

Preferably, M in formula (V) is Al, Ti, Fe or Zn.

Preferably, the telomers are those of the formula (VI)

H—(C_{w}H_{2w})ₖP(O)(OM)(CₓH₂ₓ)ₗ—H (VI)

where, in formula (VI), independently of one another,
k is 1 to 9,
l is 1 to 9,
w is 2 to 9,
x is 2 to 9,
M is Mg, Ca, Al, Sb, Sn, Ge, Ti, Fe, Zr, Zn, Ce, Bi, Sr, Mn, Li, Na, K and/or a protonated nitrogen base,

and the (C_{w}H_{2w})ₖ and (CₓH₂ₓ)ₗ groups may be linear or branched; and/or the telomers are those of the formula (I)

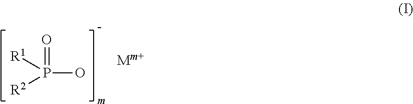

in which
R¹, R² are the same or different and are C₆-C₁₀-arylene, C₇-C₂₀-alkylarylene, C₇-C₂₀-arylalkylene and/or C₃-C₁₆-cycloalkyl or -bicycloalkyl,
M is Mg, Ca, Al, Sb, Sn, Ge, Ti, Fe, Zr, Zn, Ce, Bi, Sr, Mn, Li, Na, K and/or a protonated nitrogen base.

Preferably, in formula (VI),

w and x are each 2 to 4 and

k and l are each 1 to 4.

More preferably, in formula (VI),

w and x are each 2 or 3 and

k and l are each 1 to 3.

Preferably, M in formula (VI) and/or (I) is in each case independently Al, Ti, Fe or Zn.

Preferably, the telomers are metal salts of ethylbutylphosphinic acid, dibutylphosphinic acid, ethylhexylphosphinic acid, butylhexylphosphinic acid, ethyloctylphosphinic acid, sec-butylethylphosphinic acid, 1-ethylbutyl(butyl)phosphinic acid, ethyl(1-methylpentyl)phosphinic acid, di-sec-butylphosphinic acid (di(1-methylpropyl)phosphinic acid), propyl(hexyl)phosphinic acid, dihexylphosphinic acid, hexyl(nonyl)phosphinic acid, propyl(nonyl)phosphinic acid, dinonylphosphinic acid, dipropylphosphinic acid, butyl(octyl)phosphinic acid, hexyl(octyl)phosphinic acid, dioctylphosphinic acid, ethyl(cyclopentylethyl)phosphinic acid, butyl(cyclopentylethyl)phosphinic acid, ethyl(cyclohexylethyl)phosphinic acid, butyl(cyclohexylethyl)phosphinic acid, ethyl(phenylethyl)phosphinic acid, butyl(phenylethyl)phosphinic acid, ethyl(4-methylphenylethyl)phosphinic acid, butyl(4-methylphenylethyl)phosphinic acid, butylcyclopentylphosphinic acid, butylcyclohexylethylphosphinic acid, butylphenylphosphinic acid, ethyl(4-methylphenyl)phosphinic acid and/or butyl(4-methylphenyl)phosphinic acid, where the metal in the metal salt comes from the group of Mg, Ca, Al, Sb, Sn, Ge, Ti, Fe, Zr, Zn, Ce, Bi, Sr, Mn, Li, Na and/or K.

Preferably, the oligomers are those of the formula (II)

R³—[-E-(—CR¹R²—)ₖ—(CH₂)ₗ—CO—]ₙ—OR⁴ (II)

in which

n is 1-1 000 000,

k is 0 to 5,

l is 2 to 15,

E is O or NH,

R¹ is H,

R² is CH₃,

R³ is H, CH₃, —CO—CH(CH₃)OH or CO—C₁₋₁₀-alkyl,

R⁴ is H, CH(CH₃)CO₂H, CO—C₁₋₁₀-alkyl or

—(CH₂)ₘ—O—[CO—(CH₂)l-(CR¹R²)ₖ—)-E]ₙ-R³

in which

m is 1-20,

R¹ is H,

R² is CH₃ and

R³ is H, CH₃ or C₁₋₁₀-alkyl.

Preferably, the oligomers are also those of the formula (III)

—[—N(—CO—R¹)—(CH₂)ₗ—]ₙ— (III)

in which

n is 1-1 000 000,

l is 2 to 15 and

R¹ is CH₃.

Preferably, the oligomers are also those of the formula (IV)

—[—O—(CH₂)ₗ—CO—]ₙ— (IV)

in which

n is 1-1 000 000,

l is 2 to 15.

Preferably, the oligomers have a molar mass of 1000 g/mol to 114*10⁶ g/mol and a chain length n of 30 to 1 000 000.

Preferably, the oligomers form from lactones and/or lactams.

Preferably, the lactones are propiolactone, gamma-butyrolactone, beta-butyrolactone, delta-valerolactone and/or epsilon-caprolactone.

Preferably, the lactams are propiolactam, gamma-butyrolactam, delta-valerolactam, epsilon-caprolactam, laurolactam and/or methylpyrrolidin-2-one.

Preferably, the polymeric flame retardant mixtures further comprise synergists, where the synergists are melamine phosphate, dimelamine phosphate, pentamelamine triphosphate, trimelamine diphosphate, tetrakismelamine triphosphate, hexakismelamine pentaphosphate, melamine diphosphate, melamine tetraphosphate, melamine pyrophosphate, melamine polyphosphates, melam polyphosphates, melem polyphosphates and/or melon polyphosphates; or melamine condensation products such as melam, melem and/or melon; or oligomeric esters of tris(hydroxyethyl) isocyanurate with aromatic polycarboxylic acids, benzoguanamine, tris(hydroxyethyl) isocyanurate, allantoin, glycoluril, melamine, melamine cyanurate, urea cyanurate, dicyandiamide and/or guanidine; or nitrogen-containing phosphates of the formula (NH₄)_{y}H_{3-y}PO₄ or (NH₄PO₃)_{z} with y=1 to 3 and z=1 to 10 000; or aluminum phosphites; or silicates, zeolites, silicas, ceramic powder, zinc compounds, e.g. zinc borate, zinc carbonate, zinc stannate, zinc hydroxystannate, zinc phosphate, zinc sulfide, zinc oxide, zinc hydroxide, tin oxide hydrate, basic zinc silicate, zinc molybdate, magnesium hydroxide, hydrotalcite, magnesium carbonate and/or calcium magnesium carbonate.

The invention also encompasses polymeric flame retardant mixtures, which comprise

a) 0.1% to 70% by weight of dialkylphosphinic salt,

b) 0% to 20% by weight of telomers,

c) 30% to 99.8% by weight of oligomers and

d) 0.1% to 30% by weight of synergists, where the sum total of a), b), c) and d) is 100% by weight, with the proviso that a) and b) are different compounds.

The above object is also achieved by a process for producing polymeric flame retardant mixtures as claimed in one or more of claims 1 to 19, which comprises incorporating nanoparticulate dialkylphosphinic salt containing 0% to 20% by weight of telomers into an oligomer without the use of catalysts.

Preferably, the incorporation is effected by extruding or kneading.

A preferred process comprises subjecting standard particulate dialkylphosphinic salt having a particle size of 0.5 to 1000 μm and containing 0% to 20% by weight of telomers to wet grinding in a short-chain oligomer until the desired particle size of 10 to 1000 μm is attained.

It is preferable here that attainment of the desired particle size of 10 to 1000 μm is followed by adjustment to a chain length n of 30 to 1 000 000 in a kneader.

Preferably, the reaction mixture is heated during the grinding to 20 to 160° C. for 0.1 to 72 h.

The invention especially relates to the use of the polymeric flame retardant mixtures as claimed in one or more of claims 1 to 20 for rendering fiber molding compounds, film molding compounds, fibers and films flame-retardant.

The invention therefore also encompasses flame-retardant fiber molding compounds, film molding compounds, fibers and/or films comprising 0.1% to 80% by weight of the polymeric flame retardant mixtures as claimed in one or more of claims 1 to 20 and 20% to 99.9% by weight of thermoplastic or thermoset polymer.

These are preferably flame-retardant fiber molding compounds, film molding compounds, fibers and/or films comprising 0.1% to 50% by weight of the polymeric flame retardant mixtures as claimed in one or more of claims 1 to 20, 50% to 99.9% by weight of thermoplastic or thermoset polymer, 0% to 60% by weight of additives and 0% to 60% by weight of filler.

The invention further relates to the use of the polymeric flame retardant mixtures as claimed in one or more of claims 1 to 20 as a flame retardant for clearcoats and intumescent coatings, in or as flame retardants for wood and other cellulose products, in or as reactive and/or non-reactive flame retardants for polymers, gelcoats, unsaturated polyester resins, for production of flame-retardant polymer molding compounds, for production of flame-retardant polymer moldings, for rendering polyester and pure and blended cellulose fabrics flame-retardant by impregnation, in polyurethane foams, in polyolefins, in unsaturated polyesters and phenolic resins, for rendering textiles flame-retardant.

The polymeric flame retardant mixtures as claimed in one or more of claims 1 to 20 can be used in or for plug connectors, current-bearing components in power distributors (residual current protection), circuit boards, potting compounds, power connectors, circuit breakers, lamp housings, LED lamp housings, capacitor housings, coil elements, ventilators, grounding contacts, plugs, in/on printed circuit boards, housings for plugs, cables, flexible circuit boards, charging cables, motor covers, textile coatings and other products.

Preferred monomers are lactones and lactams.

Preferred lactones are

beta-propiolactone,

alpha,alpha-dimethyl-beta-propiolactone,

alpha,alpha-bis(trichloromethyl)-beta-propiolactone,

beta-(trichloromethyl)-beta-propiolactone,

gamma-butyrolactone,

beta,beta-bis(trichloromethyl)-beta-propiolactone,

delta-valerolactone,

gamma-methyl-valerolactone,

alpha,beta-dimethyl-delta-valerolactone,

beta,beta-dimethyl-delta-valerolactone,

gamma,gamma-dimethyl-delta-valerolactone,

gamma,gamma-diethyl-delta-valerolactone,

gamma-butyl-gamma-ethyl-delta-valerolactone,

monomethoxy-delta-valerolactone,

3,4,5-trimethoxy-delta-valerolactone,

epsilon-caprolactone,

monomethyl-epsilon-caprolactone,

monoethyl-epsilon-caprolactone,

dimethyl-epsilon-caprolactone,

diethyl-epsilon-caprolactone,

enantholactone,

the lactone of hydroxy-15-pentadecanoic acid,

dioxane-1,4-one-2,

the lactone of hydroxy-4-cyclohexanecarboxylic acid,

dioxane-1,4-dione-2,5,

the lactone of hydroxy-8-octanoic acid.

Preferred lactones are additionally delta-ethylvalerolactone, pivalolactone, ethoxyvalerolactone, poly-epsilon-methylcaprolactone, gamma-methylcaprolactone, gamma-methoxycaprolactone, delta-methylcaprolactone, epsilon-ethylcaprolactone, enantholactone, methylenantholactone, ethylenantholactone, methoxyenantholactone, ethoxyenantholactone and dimethylenantholactone.

Preferred melting points of the above lactones are −33° C. to −1.5° C.

Preferably, in the case of propiolactone,

E=O, k=0, l=2, R¹, R², R³, R⁴=H, n=1-1 000 000

Preferably, in the case of gamma-butyrolactone,

E=O, k=0, l=3, R¹, R², R³, R⁴=H, n=1-1 000 000

Preferably, in the case of beta-butyrolactone,

E=O, k=1, l=1, R¹=CH₃, R², R³, R⁴=H, n=1-1 000 000

Preferably, in the case of delta-valerolactone,

E=O, k=0, l=4, R¹, R², R³, R⁴=H, n=1-1 000 000

Preferably, in the case of epsilon-caprolactone,

E=O, k=0, l=5, R¹, R², R³, R⁴=H, n=1-1 000 000

The above details relate to formula (II).

Preference is also given to an oligomer (lactic acid dimer) of the formula (II) with E=O, k=1, l=0, R¹=CH₃, R²=H, R³=—CO—CH(CH₃)OH, R⁴=CH(CH₃)CO₂H, n=1-1 000 000.

Preferred oligomers are likewise polylactone block copolymers, for example polyester-polylactone block copolymers and/or lactone-modified polyethylene terephthalate, polylactone graft polymers, for example poly(meth)acrylate-graft-polylactone polymers, polylactone copolymers, for example polyalkyloxazoline-polylactone copolymers, polyurethane-polylactone copolymers, rubber-like block polymers, for example polylactone with rubber compounds, crosslinked polylactones, polylactone copolymers (from mixtures of various lactone monomers) and/or end-capped polylactones. In the case of end-capped polylactones, a lactone is polymerized in the presence of a suitable catalyst and then this polylactone is modified (end-capped) with a modifier and a suitable catalyst.

Modifiers preferred in the case of end-capped polylactones are ethyl acetate, propyl acetate, butyl acetate, 2-ethylhexyl acetate, ethyl acrylate, butyl methacrylate, cyclohexene acetate, cyclohexyl acetate, phenyl acetate, amyl acetate, butyl propionate, ethyl benzoate, propyl benzoate, ethylene diacetate, ethylene dibenzoate, glycerol triacetate, pentaerythritol tetraacetate, epsilon-acetoxyethyl caproate, diethyl ester of 4-thiapimelic acid, dibenzyl adipate, dimethyl terephthalate, dibutyl terephthalate, dibutyl adipate, dipropylene glycol dibenzoate, diethylene diacetate, diethylene glycol dibenzoate, diethylene glycol dibutyrate, triethylene glycol diacetate, triethylene glycol dipropionate, triethylene glycol dibenzoate, tetrapropylene glycol dipropionate and tetraethylene dibenzoate (DE-A-2161201).

Preferred modifiers are additionally alkylene ether glycols, 2,2-dimethylpropane-1,3-diol, 3-methylpentane-1,5-diol, N-methyldiethanolamine, hydroquinol, cyclohexanediols, 4,4′-methylenebiscyclohexanol, 4,4′-isopropylidenebiscyclohexanol, 1,4-bis(hydroxymethyl)benzene, glycerol, trimethylolethane, hexane-1,2,6-triol, triethanolamine, pentaerythritol, diamines, phenylenediamine, benzidine, cyclohexane-1,4-diamine, 4,4′-methylenebiscyclohexylamine, diethylenetriamine, amino alcohols, N-methylethanolamine, isopropanolamine, p-aminophenethanol and 4-aminocyclohexanol (DE-A-2234265).

It has been found that, surprisingly, dialkylphosphinic salts, especially aluminum dialkylphosphinate, promote the polymerization of the lactone. Particular aluminum salts are known per se for their catalyzing effect, but these are organoaluminum compounds, for instance diethylaluminum alkoxide (e.g. diethylaluminum methoxide) or aluminum alkoxide (e.g. aluminum alkoxide (isopropoxide) (DE-A-1815081)) and triethylaluminum amine. However, these compounds are moisture- and air-sensitive and can therefore be processed only in a restricted manner. The dialkylphosphinic salts used in accordance with the invention, especially the aluminum dialkylphosphinates, by contrast, have unlimited air and moisture stability and can therefore be used particularly efficiently for processing purposes.

Preferred oligomers are also lactams, such as propiolactam, gamma-butyrolactam, delta-valerolactam, epsilon-caprolactam, laurolactam and methylpyrrolidin-2-one.

Preferably, in the case of propiolactam,

E=NH, k=0, l=2, R¹, R², R³, R⁴=H, n=1-1 000 000

Preferably, in the case of gamma-butyrolactam,

E=NH, k=0, l=3, R¹, R², R³, R⁴=H, n=1-1 000 000

Preferably, in the case of delta-valerolactam,

E=NH, k=0, l=4, R¹, R², R³, R⁴=n=1-1 000 000

Preferably, in the case of epsilon-caprolactam,

E=NH, k=0, l=5, R¹, R², R³, R⁴=H, n=1-1 000 000

Preferably, in the case of laurolactam,

E=NH, k=0, l=11, R¹, R², R³, R⁴=H, n=1-1 000 000

Preferably, in the case of methylpyrrolidin-2-one,

E=NH, k=1, l=2, R¹=CH₃, R², R³, R⁴=H, n=1-1 000 000

The above details relate to formula (II).

Preferred melting points of the above lactams are 25 to 153° C.

Preferred oligomers are also those of the formula (VII):

—[—O—(CH₂)ₗ—]ₙ— (VII)

Preferably, here,

n is 1-1 000 000,

l is 2 to 15.

The dialkylphosphinic salts used for the present invention have a particle size of 0.010 to 100 μm, preferably of 0.50 to 2 μm. Thus, preference is given to using nanoparticulate dialkylphosphinic salts.

Preference is given to using dialkylphosphinic salts that are not fusible at temperatures below 280° C.

Telomers can form in the reaction of an olefin with a suitable phosphinate source. For example, in the reaction with ethylene, it is possible for “multiples” of ethylene products to form as telomers; for instance, 2 ethylene units go on to form a butyl group and 3 ethylene units a hexyl group.

4 ethylene units can result, for example, in a dibutyl- or ethylhexylphosphinic salt.

In principle, in the telomer formation, one or both alkyl chains of the alkylphosphinic salt are extended by one or more further olefin units. In other words, olefins add onto alkyl chains and extend the alkyl chains.

It must be pointed out explicitly here that, in the case of a reaction of an olefin with a phosphinate source, it is mainly the olefin itself, as it is, that is added onto the phosphorus atom, without telomer formation. In the reaction of ethylene, for example, with a phosphinate source, the main product is the diethylphosphinic acid product. Telomers can form in such a reaction, but do not necessarily arise.

The telomers used for the present invention have a particle size of 0.010 to 100 μm, preferably of 0.50 to 2 μm. Thus, preference is given to using nanoparticulate telomers.

The telomers described here are phosphorus compounds. The content thereof is reported in percent of all phosphorus-containing ingredients. It is determined by means of ³¹P NMR.

Production of Flame Retardant Mixtures of the Invention

Known processes such as the melt intercalation of poly(epsilon-lactone) with nanoparticulate clay minerals such as aluminum-containing montmorillonite, which is also used in polymeric flame retardant mixtures, require the organochemical modification of the clay mineral with quaternary ammonium salts. This measure is detrimental to flame retardancy, since ammonium salts are combustible. Organochemical modification of compounds or materials is neither necessary nor desirable for the production of the polymeric flame retardant mixtures of the invention.

In a preferred process for producing polymeric flame retardant mixtures of the invention, by contrast, nanoparticulate flame retardant is incorporated into an oligomer suitable in accordance with the invention.

Preferred processes for this purpose are incorporation by extrusion, preferably in single- or twin-shaft extruders, and incorporation by kneading, preferably in kneaders.

The process of the invention differs from the prior art in that the dialkylphosphinic salt intervenes in the polymerization process, i.e. serves as catalyst itself, and is not just present as an inert substance in the polymerization. In the prior art, it is necessary to use additional catalysts, for example titanium compounds (WO-A-2008/061075).

The inventive catalytic action of the dialkylphosphinic salts is surprising since it is known that phosphorus-containing catalysts (phosphines) do not produce molar masses suitable for fibers (DE-A-1745397), or suitable polymers can only be produced using further additions (bismuth nitrate).

In an alternative preferred process 1 for production of polymeric flame retardant mixtures of the invention, standard particulate flame retardant, in a first step, is subjected to wet grinding in a short-chain oligomer, for example in a bead mill, and, after attainment of the desired particle size, the preferred chain length of the oligomer is produced.

The standard particulate flame retardant has a mean grain size d₅₀ of 0.5 to 500 μm, preferably of 5 to 100 μm.

The preferred short-chain oligomer, prior to grinding, has a chain length n of 1 to 10 000, more preferably of 1 to 1000.

The preferred process for wet grinding is bead grinding.

A preferred oligomer in the polymeric flame retardant mixture of the invention has a chain length of n of 10 to 1 000 000; more preferably, n is from 30 to 1 000 000.

The process of the invention differs significantly from the prior art, in which, typically, a flame retardant is introduced into the polymer during or after the polymerization and the particle size of the flame retardant remains unchanged therein (WO-A-2008/061075, WO-A-2012/144653).

In an alternative preferred process 2 for production of polymeric flame retardant mixtures of the invention, standard particulate flame retardant is subjected to wet grinding in a short-chain oligomer and the preferred chain length of the oligomer is produced during the grinding to the desired particle size.

The grinding is effected, for example, in a bead mill.

Preference is given to heating to 70 to 170° C. for 0.1 to 72 h during the grinding.

Preferably, the chain length of the oligomer, after grinding, can be finely adjusted to a value of 30 to 1 000 000 by thermal treatment.

The short-chain oligomers used with preference, on commencement of grinding, have a chain length n of 1 to 1000 and, after grinding, one of 30 to 1 000 000.

In process 1 of the invention, dialkylphosphinic salt is wet-ground with oligomer and then the chain length is finely adjusted in a kneader.

In process 2 of the invention, dialkylphosphinic salt is wet-ground with oligomer without an additional kneader.

| Chain length n | Process 1 | Process 2 |
|---|---|---|
| Before grinding | 1-1000 | 1-1000 |
| After grinding | 10-1000 | 10-1000 |
| After fine adjustment | 30-1 000 000 | |

The polymeric flame retardant mixtures of the invention can be used in and incorporated into thermoplastic polymers (for instance polyester, polystyrene or polyamide) and thermoset polymers.

The thermoplastic polymers preferably come from the group of polyester, polyolefin, polystyrene, polyamide, polyacrylonitrile, polyvinyl chloride, poly(vinylidene chloride) and copolymers thereof, polyvinyl alcohol, polytetrafluoroethylene and aramid.

The polymers are preferably polymers of mono- and diolefins, for example polypropylene, polyisobutylene, polybutene-1, poly-4-methylpentene-1, polyisoprene or polybutadiene, and addition polymers of cycloolefins, for example of cyclopentene or norbornene; and also polyethylene (which may optionally be crosslinked), e.g. high-density polyethylene (HDPE), high-density high-molar mass polyethylene (HDPE-HMW), high-density ultrahigh-molar mass polyethylene (HDPE-UHMW), medium-density polyethylene (MDPE), low-density polyethylene (LDPE), linear low-density polyethylene (LLDPE), branched low-density polyethylene (BLDPE), and mixtures thereof.

The polymers are preferably copolymers of mono- and diolefins with one another or with other vinyl monomers, for example ethylene-propylene copolymers, linear low-density polyethylene (LLDPE) and mixtures thereof with low-density polyethylene (LDPE), propylene-butene-1 copolymers, propylene-isobutylene copolymers, ethylene-butene-1 copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers and copolymers thereof with carbon monoxide, or ethylene-acrylic acid copolymers and salts thereof (ionomers), and also terpolymers of ethylene with propylene and a diene such as hexadiene, dicyclopentadiene or ethylidenenorbornene; and also mixtures of such copolymers with one another, for example polypropylene/ethylene-propylene copolymers, LDPE/ethylene-vinyl acetate copolymers, LDPE/ethylene-acrylic acid copolymers, LLDPE/ethylene-vinyl acetate copolymers, LLDPE/ethylene-acrylic acid copolymers and alternating or random polyalkylene/carbon monoxide copolymers and mixtures thereof with other polymers, for example polyamides.

Preferred polyolefins are polypropylene and high-density polyethylene.

The polymers are preferably hydrocarbon resins (e.g. C₅ to C₉), including hydrogenated modifications thereof (e.g. tackifier resins) and mixtures of polyalkylenes and starch.

The polymers are preferably polystyrene (Polystyrol® 143E (BASF)), poly(p-methylstyrene), poly(alpha-methylstyrene).

The polymers are preferably copolymers of styrene or alpha-methylstyrene with dienes or acrylic derivatives, for example styrene-butadiene, styrene-acrylonitrile, styrene-alkyl methacrylate, styrene-butadiene-alkyl acrylate and methacrylate, styrene-maleic anhydride, styrene-acrylonitrile-methyl acrylate; high impact resistance mixtures of styrene copolymers and another polymer, for example a polyacrylate, a diene polymer or an ethylene-propylene-diene terpolymer; and block copolymers of styrene, for example styrene-butadiene-styrene, styrene-isoprene-styrene, styrene-ethylene/butylene-styrene or styrene-ethylene/propylene-styrene.

The polymers are preferably graft copolymers of styrene or alpha-methylstyrene, for example styrene on polybutadiene, styrene on polybutadiene-styrene or polybutadiene-acrylonitrile copolymers, styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene, styrene and alkyl acrylates/alkyl methacrylates on polybutadiene, styrene and acrylonitrile on ethylene-propylene-diene terpolymers, styrene and acrylonitrile on polyalkyl acrylates or polyalkyl methacrylates, styrene and acrylonitrile on acrylate-butadiene copolymers, and mixtures thereof, such as are known, for example, as ABS, MBS, ASA or AES polymers.

The styrene polymers are preferably comparatively coarse-pore foam such as EPS (expanded polystyrene), e.g. Styropor (BASF) and/or foam with relatively fine pores such as XPS (extruded rigid polystyrene foam), e.g. Styrodur® (BASF). Preference is given to polystyrene foams, for example Austrotherm® XPS, Styrofoam® (Dow Chemical), Floormate®, Jackodur®, Lustron®, Roofmate®, Sagex® and Telgopor®.

The polymers are preferably halogenated polymers, for example polychloroprene, chlorine rubber, chlorinated and brominated copolymer of isobutylene-isoprene (halobutyl rubber), chlorinated or chlorosulfonated polyethylene, copolymers of ethylene and chlorinated ethylene, epichlorohydrin homo- and copolymers, especially polymers of halogenated vinyl compounds, for example polyvinyl chloride, polyvinylidene chloride, polyvinyl fluoride, polyvinylidene fluoride; and copolymers thereof, such as vinyl chloride-vinylidene chloride, vinyl chloride-vinyl acetate or vinylidene chloride-vinyl acetate.

The polymers are preferably polymers deriving from alpha-, beta-unsaturated acids and derivatives thereof, such as polyacrylates and polymethacrylates, butyl acrylate-impact-modified polymethylmethacrylates, polyacrylamides and polyacrylonitriles and copolymers of the cited monomers with one another or with other unsaturated monomers, for example acrylonitrile-butadiene copolymers, acrylonitrile-alkyl acrylate copolymers, acrylonitrile-alkoxyalkyl acrylate copolymers, acrylonitrile-vinyl halide copolymers or acrylonitrile-alkyl methacrylate-butadiene terpolymers.

The polymers are preferably also polymers deriving from unsaturated alcohols and amines or from the acyl derivatives or acetals thereof, such as polyvinyl alcohol, polyvinyl acetate, stearate, benzoate or maleate, polyvinyl butyral, polyallyl phthalate, polyallylmelamine; and copolymers thereof with olefins.

The polymers are preferably homo- and copolymers of cyclic ethers, such as polyalkylene glycols, polyethylene oxide, polypropylene oxide or copolymers thereof with bisglycidyl ethers.

The polymers are preferably polyacetals, such as polyoxymethylene, and those polyoxymethylenes which comprise comonomers, for example ethylene oxide; polyacetals modified with thermoplastic polyurethanes, acrylates or MBS.

The polymers are preferably polyphenylene oxides and sulfides and mixtures thereof with styrene polymers or polyamides.

The polymers are preferably polyurethanes deriving from polyethers, polyesters and polybutadienes having both terminal hydroxyl groups and aliphatic or aromatic polyisocyanates, and the precursors thereof.

The polymers are preferably polyamides and copolyamides which derive from diamines and dicarboxylic acids and/or from aminocarboxylic acids or the corresponding lactams, such as nylon 2/12, nylon 4 (poly-4-aminobutyric acid, Nylon® 4, from DuPont), nylon 4/6 (poly(tetramethyleneadipamide), poly(tetramethyleneadipdiamide), Nylon® 4/6, from DuPont), nylon 6 (polycaprolactam, poly-6-aminohexanoic acid, Nylon® 6, from DuPont, Akulon K122, from DSM; Zytel® 7301, from DuPont; Durethan® B 29, from Bayer), nylon 6/6 ((poly(N,N′-hexamethyleneadipamide), Nylon® 6/6, from DuPont, Zytel® 101, from DuPont; Durethan A30, Durethan® AKV, Durethan® AM, from Bayer; Ultramid® A3, from BASF), nylon 6/9 (poly(hexamethylenenonanamide), Nylon® 6/9, from DuPont), nylon 6/10 (poly(hexamethylenesebacamide), Nylon® 6/10, from DuPont), nylon 6/12 (poly(hexamethylenedodecanediamide), Nylon® 6/12, from DuPont), nylon 6/66 (poly(hexamethyleneadipamide-co-caprolactam), Nylon® 6/66, from DuPont), nylon 7 (poly-7-aminoheptanoic acid, Nylon® 7, from DuPont), nylon 7,7 (polyheptamethylenepimelamide, Nylon® 7,7, from DuPont), nylon 8 (poly-8-aminooctanoic acid, Nylon® 8, from DuPont), nylon 8,8 (polyoctamethylenesuberamide, Nylon® 8,8, from DuPont), nylon 9 (poly-9-aminononanoic acid, Nylon® 9, from DuPont), nylon 9,9 (polynonamethyleneazelamide, Nylon® 9,9, from DuPont), nylon 10 (poly-10-aminodecanoic acid, Nylon® 10, from DuPont), nylon 10,9 (poly(decamethyleneazelamide), Nylon® 10,9, from DuPont), nylon 10,10 (polydecamethylenesebacamide, Nylon® 10,10, from DuPont), nylon 11 (poly-11-aminoundecanoic acid, Nylon® 11, from DuPont), nylon 12 (polylauryllactam, Nylon® 12, from DuPont, Grillamid® L20, from Ems Chemie), aromatic polyamides proceeding from m-xylene, diamine and adipic acid; polyamides prepared from hexamethylenediamine and iso- and/or terephthalic acid (polyhexamethyleneisophthalamide, polyhexamethyleneterephthalamide) and optionally an elastomer as a modifier, e.g. poly-2,4,4-trimethylhexamethyleneterephthalamide or poly-m-phenyleneisophthalamide. Block copolymers of the abovementioned polyamides with polyolefins, olefin copolymers, ionomers or chemically bonded or grafted elastomers; or with polyethers, for example with polyethylene glycol, polypropylene glycol or polytetramethylene glycol. In addition, polyamides or copolyamides modified with EPDM (ethylene-propylene-diene rubber) or ABS (acrylonitrile-butadiene-styrene); and polyamides condensed during processing (“RIM polyamide systems”).

The polymers are preferably polyureas, polyimides, polyamidimides, polyetherimides, polyesterimides, polyhydantoins and polybenzimidazoles.

The polymers are preferably polyesters which derive from dicarboxylic acids and dialcohols and/or from hydroxycarboxylic acids or the corresponding lactones, such as polyethylene terephthalate, polybutylene terephthalate (Celanex® 2500, Celanex® 2002, from Celanese; Ultradur®, from BASF), poly-1,4-dimethylolcyclohexane terephthalate, polyhydroxybenzoates, and block polyether esters which derive from polyethers with hydroxyl end groups; and also polyesters modified with polycarbonates or MBS.

Preferred polyesters are polyethylene terephthalate homopolymers and copolymers, for example with 5-sulfoisophthalic acid for better colorability, block copolymers with polyglycols, polybutylene terephthalate, poly(1,4-dimethylenecyclohexane) terephthalate and polytrimethylene terephthalate.

Dicarboxylic acid starting materials used for the polyesters are preferably 0 to 10 mole percent of other dicarboxylic acids, for example isophthalic acid, 5-sulfoisophthalic acid, 5-sulfopropoxyisophthalic acid, naphthalene-2,6-dicarboxylic acid, diphenyl-p,p′-dicarboxylic acid, p-phenylenediacetic acid, diphenyl oxide-p,p′-dicarboxylic acid, diphenoxyalkanedicarboxylic acids, trans-hexahydrophthalic acid, adipic acid, sebacic acid, cyclobutane-1,2-dicarboxylic acid and others.

Diol components used for the polyesters are, as well as ethylene glycol, preferably 0 to 10 mole percent of other diols, for example propane-1,3-diol, butane-1,4-diol, higher homologs of butane-1,4-diol, 2,2-dimethylpropane-1,3-diol, 1,4-cyclohexaneethanol and others.

Suitable polyesters are polyethylene terephthalate, polytrimethylene terephthalate, polybutylene terephthalate, polyethylene naphthalate and polytrimethylene naphthalate.

Preferred polyethylene terephthalates are Polyclear® RT 51 or Polyclear® 330 from Invista.

The polymers are preferably polycarbonates and polyester carbonates, and also polysulfones, polyether sulfones and polyether ketones.

The polymers are preferably crosslinked polymers which derive from aldehydes on the one hand, and phenols, urea or melamine on the other hand, such as phenol-formaldehyde, urea-formaldehyde and melamine-formaldehyde resins.

The polymers are preferably drying and nondrying alkyd resins.

The polymers are preferably unsaturated polyester resins which derive from copolyesters of saturated and unsaturated dicarboxylic acids with polyhydric alcohols, and vinyl compounds as crosslinking agents, and also the halogenated, flame-retardant modifications thereof.

The polymers are preferably crosslinkable acrylic resins which derive from substituted acrylic esters, for example from epoxy acrylates, urethane acrylates or polyester acrylates.

The polymers are preferably alkyd resins, polyester resins and acrylate resins which have been crosslinked with melamine resins, urea resins, isocyanates, isocyanurates, polyisocyanates or epoxy resins.

The polymers are preferably crosslinked epoxy resins which derive from aliphatic, cycloaliphatic, heterocyclic or aromatic glycidyl compounds, for example products of bisphenol A diglycidyl ethers, bisphenol F diglycidyl ethers, which are crosslinked by means of customary hardeners, for example anhydrides or amines, with or without accelerators.

The polymers are preferably mixtures (polyblends) of the abovementioned polymers, for example PP/EPDM (polypropylene/ethylene-propylene-diene rubber), polyamide/EPDM or ABS (polyamide/ethylene-propylene-diene rubber or acrylonitrile-butadiene-styrene), PVC/EVA (polyvinyl chloride/ethylene-vinyl acetate), PVC/ABS (polyvinyl chloride/acrylonitrile-butadiene-styrene), PVC/MBS (polyvinyl chloride/methacrylate-butadiene-styrene), PC/ABS (polycarbonate/acrylonitrile-butadiene-styrene), PBTP/ABS (polybutylene terephthalate/acrylonitrile-butadiene-styrene), PC/ASA (polycarbonate/acrylic ester-styrene-acrylonitrile), PC/PBT (polycarbonate/polybutylene terephthalate), PVC/CPE (polyvinyl chloride/chlorinated polyethylene), PVC/acrylates (polyvinyl chloride/acrylates, POM/thermoplastic PUR (polyoxymethylene/thermoplastic polyurethane), PC/thermoplastic PUR (polycarbonate/thermoplastic polyurethane), POM/acrylate (polyoxymethylene/acrylate), POM/MBS (polyoxymethylene/methacrylate-butadiene-styrene), PPO/HIPS (polyphenylene oxide/high-impact polystyrene), PPO/PA 6,6 (polyphenylene oxide/nylon 6,6) and copolymers, PA/HDPE (polyamide/high-density polyethylene), PA/PP (polyamide/polyethylene), PA/PPO (polyamide/polyphenylene oxide), PBT/PC/ABS (polybutylene terephthalate/polycarbonate/acrylonitrile-butadiene-styrene) and/or PBT/PET/PC (polybutylene terephthalate/polyethylene terephthalate/polycarbonate).

Preferred polyacrylonitriles are acrylonitrile-styrene-methacryloyl copolymers and acrylonitrile-vinyl chloride copolymers.

Preferred thermoset polymers are polyurethanes, cellulose and viscose. According to the invention, the flame-retardant fiber and film polymer molding compound is produced by compounding.

Preferred further additives in the flame-retardant fiber and film polymer molding compounds are from the group of the carbodiimides and/or (poly)isocyanates.

Preferred further additives come from the group of the sterically hindered phenols (e.g. Hostanox® OSP 1), sterically hindered amines and light stabilizers (e.g. Chimasorb® 944, Hostavin® products), phosphonites and antioxidants (e.g. Sandostab® P-EPQ from Clariant) and separating agents (Licomont® products from Clariant).

Preferred fillers in the flame retardant mixtures of the invention are oxygen compounds of silicon, magnesium compounds, metal carbonates of metals of the second main group of the Periodic Table, magnesium oxide, magnesium hydroxide, hydrotalcites, dihydrotalcite, magnesium carbonates or magnesium calcium carbonates, calcium compounds, e.g. calcium hydroxide, calcium oxide, hydrocalumite, aluminum compounds, e.g. aluminum oxide, aluminum hydroxide, boehmite, gibbsite or aluminum phosphate, red phosphorus, zinc compounds or aluminum compounds.

Preferred further fillers are glass beads.

Glass fibers are preferably used as reinforcing materials.

Preferred fiber weights in the form of single filaments are 1.5 to 11 dtex.

[Dtex is a unit of measurement that gives the weight of a filament in relation to its length. For dtex, this is the weight per 10 km of filament.]

Production, processing and testing of flame-retardant fiber and film polymer molding compounds

Compounding units usable in accordance with the invention are multizone screw extruders having three-zone screws and/or short compression screws.

Compounding units usable in accordance with the invention are also co-kneaders from Coperion Buss Compounding Systems, Pratteln, Switzerland, e.g. MDK/E46-11D, and/or laboratory kneaders (MDK 46 from Buss, Switzerland with L=11D).

Compounding units usable in accordance with the invention are twin-screw extruders, for example from Coperion Werner & Pfleiderer GmbH & Co. KG, Stuttgart (ZSK 25, ZSK 30, ZSK 40, ZSK 58, ZSK MEGAcompounder 40, 50, 58, 70, 92, 119, 177, 250, 320, 350, 380) and/or from Berstorff GmbH, Hanover, Leistritz Extrusionstechnik GmbH, Nuremberg.

Compounding units usable in accordance with the invention are ring extruders, for example from 3+Extruder GmbH, Laufen, with a ring of three to twelve small screws which rotate about a static core, and/or planetary gear extruders, for example from Entex, Bochum, and/or vented extruders and/or cascade extruders and/or Maillefer screws.

Compounding units usable in accordance with the invention are compounders with a contrarotatory twin screw, for example Complex 37 and 70 models from Krauss-Maffei Berstorff.

Screw lengths effective in accordance with the invention are 20 to 40D in the case of single-shaft extruders or single-screw extruders.

Screw lengths (L) effective in accordance with the invention in the case of multizone screw extruders are, for example, 25D with an intake zone (L=10D), transition zone (L=6D) and ejection zone (L=9D).

Screw lengths effective in accordance with the invention in the case of twin-screw extruders are 8 to 48D.

Surprisingly, the solution to the stated problem has been found in that the polymeric flame retardant mixtures of the invention can be produced by bead-grinding (wet-grinding) the coarse-grain flame retardants in an oligomer of sufficiently low viscosity.

It has been found that, surprisingly, the aforementioned oligomers can be used in accordance with the invention. However, the chain length thereof does not remain constant, but grows in the course of grinding. Surprisingly, the viscosity of the oligomer remains low enough for a lasting and constant grinding effect.

This is surprising since, according to the prior art known to date, an excessively high viscosity of a solvent prevents the grinding motion of the grinding bodies, and so no utilizable product is obtained.

The aforementioned chain growth of the oligomer in the polymeric flame retardant mixtures is attributable to the specific surprising catalyst effect of the flame retardant of the invention. The chain length can be adjusted if necessary by subsequent further heating. Owing to its polymeric character, the oligomer does not disrupt the fiber and film properties in the later end product.

The polymeric flame retardant mixture obtained can be processed in a favorable manner within the scope of the object of the invention stated at the outset, meaning that it can be incorporated into known fiber and film polymers by extrusion via processes according to the prior art, such that the fiber and film molding compounds of the invention are obtained. These can then be processed as usual by melt spinning, fiber modification and yarn fabrication methods to give filaments and fibers and processed by film blowing methods to give films.

Noninventive aluminum-containing flame retardants, for example aluminum hydroxide, aluminum hypophosphite, do not show any polymerization. The mixture of unpolymerized oligomer and flame retardant of fineness 0.01-100 μm obtainable therefrom, owing to the low molar mass of the oligomer, cannot be processed to give flame-retardant fiber and film molding compounds of the invention.

For production of flame-retardant polymer molding compounds, the polymeric flame retardant mixtures of the invention are mixed with the polymer pellets and possibly additives, and incorporated via the side intake of a twin-screw extruder (Leistritz ZSE 27/44D) at temperatures of 230 to 260° C. (PET), into PA 6,6 at 260-310° C. or into PA 6 at 250-275° C. The homogenized polymer strand was drawn off, cooled in a water bath and then pelletized to give the flame-retardant polymer molding compounds.

### Production of Flame-Retardant Fibers and Measurement of the Flame Retardancy Properties:

The flame-retardant fiber and film polymer molding compound is spun by known methods by melt-spinning to give fiber filaments and then processed with a knitting machine on the pilot plant scale to give a knitted sock or knitted tube. A piece of fabric is cut out of this and the LOI is determined by the general method.

Identification of the Telomers and Determination of the Content Thereof in Mixtures with Dialkylphosphinic Salts:

The ³¹P NMR spectra are measured with a Jeol JNM-ECS-400 instrument, a 400 MHz NMR instrument from JEOL (Germany) GmbH. A sample of 400 mg is dissolved in 2 mL of 10% by weight NaOD/D₂O by gentle heating of the sample to about 40° C. The measurement is conducted in {1H}-decoupled mode with 2048 scans.

With the aid of table 1, it is possible to infer the ³¹P NMR signals of telomers from a ³¹P NMR spectrum. The ³¹P NMR integration values give the percentage of ³¹P nuclei based on all ³¹P nuclei in the sample. For each substance, these integrations are multiplied by an individual factor (f=MW (telomer as Al salt) divided by 3*AW (phosphorus) [MW: molecular weight, AW: atomic weight]). All such values for the dialkylphosphinic salt and all telomers as Al salts are added up and hence an interim sum total is determined. The value for the dialkylphosphinic salt and all telomers as Al salts are each multiplied by 100 and divided by the interim sum total. In this way, the content of telomers as Al salts in % by weight in the mixture of the invention with dialkylphosphinic salt is obtained.

TABLE 1
³¹P NMR chemical shift of telomers as Al salts

| | ³¹P NMR chemical shift |
|---|---|
| Aluminum dialkylphosphinate | [ppm] |
| aluminum tris(diethylphosphinate) | 50.435-49.785 |
| aluminum tris(i- | 51.830-51.752 |
| butylethylphosphinate) | |
| aluminum tris(n- | 49.031-48.866 |
| butylethylphosphinate) | |
| aluminum tris(n- | 48.693-48.693 |
| hexylethylphosphinate) | |
| aluminum tris(sec- | about 51.72 |
| hexylethylphosphinate) | |
| aluminum tris(di-n-butylphosphinate) | 47.696-47.622 |
| aluminum tris(di-sec- | 52.861-52.861 |
| butylphosphinate) | |
| aluminum tris(n- | 46.795-46.795 |
| octylethylphosphinate) | |

### Gel Permeation Chromatography (GPC) Analysis

1 g/L of the polymeric flame retardant mixtures are introduced into tetrahydrofuran (THF) and stirred for 3 hours. After the time has elapsed, the oligomer is dissolved and the insoluble dialkylphosphinic salt can be removed by means of a syringe filter (200 nm). The clear THF solution with the dissolved oligomer is then injected into the GPC instrument and the molar mass is measured against a polystyrene standard.

### Melt Pump Test

A twin-screw extruder (screw diameter 16 mm) is used to incorporate a sufficient amount of polymeric flame retardant mixture of the invention into a PET polymer (Polyclear® RT 51 from Invista) to correspond to an amount of 5% by weight of dialkylphosphinic salt. About 800 g of flame-retardant fiber and film polymer molding compound are obtained. Subsequently, a pressure filter test is conducted (DIN EN 13900-5) by discharging the flame-retardant fiber and film polymer molding compound with the aid of a melt pump through a defined sieve (mesh size 14 μm) with defined sieve area and a given mesh size. After passage of the about 800 g of flame-retardant fiber and film polymer molding compound, the sieve becomes blocked to an ever greater degree by specks or agglomerates, and causes a rise in pressure as a result.

### Determination of Flame Retardancy Properties on Flame-Retardant Polymer Moldings:

An important measurement for declaration of flame-retardant substances is the limiting oxygen index, the minimum value of oxygen in the atmosphere at which a substance to be examined burns. In the course of this, the oxygen content in the ambient air is increased continuously. A higher LOI value indicates better flame retardancy.

| | | |
|---|---|---|
| LOI | 23 | flammable |
| LOI | 24-28 | limited flammability |
| LOI | 29-35 | flame-retardant |
| LOI | >36 | particularly flame-retardant |

The invention is illustrated by the examples which follow.

Substances and abbreviations used:
DPS-1: Mixture of 94 mol % of aluminum diethylphosphinate, 5 mol % of aluminum n-butylethylphosphinate and 1 mol % of aluminum sec-butylethylphosphinate.
DPS-2: 100 mol % of aluminum diethylphosphinate.
DPS-3: Mixture of 96 mol % of aluminum diethylphosphinate and 5 mol % of aluminum di-n-butylethylphosphinate.
DPS-4: Mixture of 66 mol % of aluminum diethylphosphinate and 34 mol % of aluminum n-butylethylphosphinate.
DPS-5: Mixture of 98.9 mol % of aluminum diethylphosphinate and 0.11 mol % of aluminum ethyl(phenylethyl)phosphinate.
DPS-6: Mixture of 90.5 mol % of aluminum diethylphosphinate and 9.5 mol % of aluminum butyl(4-methylphenylethyl)phosphinate.
DPS-7: Mixture of 99.2 mol % of aluminum diethylphosphinate and 0.8 mol % of aluminum ethyl(cyclopentylethyl)phosphinate.
DPS-8: Mixture of 91.3 mol % of aluminum diethylphosphinate and 8.7 mol % of aluminum butyl(cyclohexylethyl)phosphinate.
DSP: Dispersing aid; polyethyleneimine grafted with polyester.
Grinding beads: Silibeads®, ZC type (diameter 0.4-0.6 mm)
ATH: aluminum hydroxide, Apyral® 1E type from Nabaltec with d₅₀=about 45 μm.
OP935: aluminum diethylphosphinate, Exolit® OP 935 from Clariant with d₅₀=2.5 μm and d₉₅=8 μm.
n: number of polymeric repeat units; polymer chain length.

### EXAMPLE 1

DPS-1 (150 g) is stirred into 200 g of epsilon-caprolactone with a spatula at room temperature. Then the grinding beads are added and grinding is effected with a grinding disk at 300 rpm for 6 h in a Dispermat AE mill from VMA Getzmann at room temperature and then the grinding beads are removed with a centrifuge. The mean grain diameter is measured with a Malvern Mastersizer laser diffraction particle size measuring instrument and found to be 0.239 μm. 100 g of the diethylphosphinic salt/telomer/oligomer mixture obtained are introduced into a thermostatted duplex kneader from Flender Himmel (HKD-T06-D, equipped with a nitrogen connection) and heated to about 160° C. in an N₂ counterflow (5 L/h) and at 100 rpm for 8 hours, then the reaction mixture is cooled down to room temperature with continuous kneading and kneaded for a further 2 hours. The polymeric flame retardant mixture is obtained in the form of fine granules. The yield is quantitative. Polymerization is demonstrated by measuring a GPC. The batch and analysis data, including the melt pump test and the flame retardancy properties, are listed in table 2. The ratio of dialkylphosphinic salt to telomer in the polymeric flame retardant mixture is the same as in the starting material.

### EXAMPLE 2

Analogously to example 1, 200 g of DPS-1 are stirred into a mixture of 228 g of epsilon-caprolactone and 8.8 g of dispersing aid. The melt pump test and flame retardancy properties are good and comparable with example 1. The batch, analysis and test data are listed in table 2. The ratio of dialkylphosphinic salt to telomer in the polymeric flame retardant mixture is the same as in the starting material.

### EXAMPLE 3

Analogously to example 2, DPS-2 is ground at 50° C. The melt pump test and flame retardancy properties are good and comparable with example 2. The batch, analysis and test data are listed in table 2. The ratio of dialkylphosphinic salt to telomer in the polymeric flame retardant mixture is the same as in the starting material.

### EXAMPLE 4

Analogously to example 2, DPS-3 is ground at 100° C. The melt pump test and flame retardancy properties are good and comparable with example 2. The batch, analysis and test data are listed in table 2. The ratio of dialkylphosphinic salt to telomer in the polymeric flame retardant mixture is the same as in the starting material.

### EXAMPLE 5

Analogously to example 2, DPS-4 is ground at 20° C. The melt pump test and flame retardancy properties are good and comparable with example 2. The batch, analysis and test data are listed in table 2. The ratio of dialkylphosphinic salt to telomer in the polymeric flame retardant mixture is the same as in the starting material.

### EXAMPLE 6

Analogously to example 2, DPS-5 is ground at 20° C. The melt pump test and flame retardancy properties are good and comparable with example 2. The batch, analysis and test data are listed in table 2. The ratio of dialkylphosphinic salt to telomer in the polymeric flame retardant mixture is the same as in the starting material.

### EXAMPLE 7

Analogously to example 2, DPS-6 is ground at 20° C. The melt pump test and flame retardancy properties are good and comparable with example 2. The batch, analysis and test data are listed in table 2. The ratio of dialkylphosphinic salt to telomer in the polymeric flame retardant mixture is the same as in the starting material.

### EXAMPLE 8

Analogously to example 2, DPS-7 is ground at 20° C. The melt pump test and flame retardancy properties are good and comparable with example 2. The batch, analysis and test data are listed in table 2. The ratio of dialkylphosphinic salt to telomer in the polymeric flame retardant mixture is the same as in the starting material.

### EXAMPLE 9

Analogously to example 2, DPS-8 is ground at 20° C. The melt pump test and flame retardancy properties are good and comparable with example 2. The batch, analysis and test data are listed in table 2. The ratio of dialkylphosphinic salt to telomer in the polymeric flame retardant mixture is the same as in the starting material.

### EXAMPLE 10

Analogously to example 2, DPS-1 is ground for 2 hours. Polymerization is weaker than in example 2. The melt pump test and flame retardancy properties are good and comparable with example 2. The batch, analysis and test data are listed in table 2. The ratio of dialkylphosphinic salt to telomer in the polymeric flame retardant mixture is the same as in the starting material.

### EXAMPLE 11

Analogously to example 2, 300 g of DPS-1 are ground with 800 g of grinding beads. Polymerization is weaker than in example 2. The melt pump test and flame retardancy properties are good and comparable with example 2. The batch, analysis and test data are listed in table 2. The ratio of dialkylphosphinic salt to telomer in the polymeric flame retardant mixture is the same as in the starting material.

### EXAMPLE 12

DPS-1 (200 g) is stirred into 228 g of delta-valerolactone at room temperature. Then the grinding beads are added and grinding is effected with a grinding disk at 300 rpm for 10 h in a Dispermat AE mill from VMA Getzmann, beginning at room temperature and ending at about 160° C., and then the grinding beads are removed with a centrifuge. The mean grain diameter is measured with a Malvern Mastersizer laser diffraction particle size measuring instrument and found to be 0.201 μm.

The polymeric flame retardant mixture is obtained in the form of fine granules. The yield is quantitative. Polymerization is demonstrated by measuring a GPC. The batch data, analysis data and test data, including the melt pump test and the flame retardancy properties, are listed in table 2.

The melt pump test and flame retardancy properties are good and comparable with example 2. The ratio of dialkylphosphinic salt to telomer in the polymeric flame retardant mixture is the same as in the starting material.

### EXAMPLE 13

Analogously to example 2, 233 g of DPS-1 are ground with 173 g of gamma-butyrolactone and 700 g of grinding beads. Polymerization is weaker than in example 2. The melt pump test and flame retardancy properties are good and comparable with example 2. The batch, analysis and test data are listed in table 2. The ratio of dialkylphosphinic salt to telomer in the polymeric flame retardant mixture is the same as in the starting material.

### EXAMPLE 14 (COMPARATIVE)

Analogously to example 2, aluminum hydroxide is ground. No effective polymerization takes place. Owing to its low molar mass (see table 2), the material cannot be processed to give a flame-retardant fiber and film polymer molding compound of the invention. The batch, analysis and test data are listed in table 2.

### EXAMPLE 15 (COMPARATIVE)

5% by weight of DPS-1, which, with a d₅₀ of 2.5 μm and a d₉₅ of 8 μm, is coarser than the diethylphosphinic salt of the invention or the mixture of diethylphosphinic salt and telomer of the invention, is processed to give a flame-retardant fiber and film polymer molding compound. The melt pump test leads to a significant rise in pressure (blockage). The material cannot be processed to give a flame-retardant fiber and film polymer molding compound of the invention. The test data are listed in table 2.

The positive properties of the polymeric flame retardant mixtures of the invention that were found in the examples were also obtained when a mixture of diethylphosphinic salt and propylhexylphosphinic salt (telomer) or a mixture of dipropylphosphinic salt and propylhexylphosphinic salt (telomer) was used.

TABLE 2

| | Grinding | | | | | | | | |
|---|---|---|---|---|---|---|---|---|---|
| | Starting | | Carrier | | | | Grinding | Grinding | Grinding |
| | material | | material | | Dispersant | | beads | time | temp. |
| Example | | [g] | Name | [g] | Name | [g] | Amount | [h] | [° C.] |
| 1 | DPS 1 | 150 | epsilon- | 200 | — | — | 1400 | 6 | 20 |
| | | | caprolactone | | | | | | |
| 2 | DPS 1 | 200 | epsilon- | 228 | DSP | 8.8 | 1400 | 6 | 20 |
| | | | caprolactone | | | | | | |
| 3 | DPS 2 | 200 | epsilon- | 228 | DSP | 8.8 | 1400 | 6 | 50 |
| | | | caprolactone | | | | | | |
| 4 | DPS 3 | 200 | epsilon- | 228 | DSP | 8.8 | 1400 | 6 | 100 |
| | | | caprolactone | | | | | | |
| 5 | DPS 4 | 200 | epsilon- | 228 | DSP | 8.8 | 1400 | 6 | 20 |
| | | | caprolactone | | | | | | |
| 6 | DPS 5 | 200 | epsilon- | 228 | DSP | 8.8 | 1400 | 6 | 20 |
| | | | caprolactone | | | | | | |
| 7 | DPS 6 | 200 | epsilon- | 228 | DSP | 8.8 | 1400 | 6 | 20 |
| | | | caprolactone | | | | | | |
| 8 | DPS 7 | 200 | epsilon- | 228 | DSP | 8.8 | 1400 | 6 | 20 |
| | | | caprolactone | | | | | | |
| 9 | DPS 8 | 200 | epsilon- | 228 | DSP | 8.8 | 1400 | 6 | 20 |
| | | | caprolactone | | | | | | |
| 10 | DPS 1 | 200 | epsilon- | 228 | DSP | 8.8 | 1400 | 2 | 20 |
| | | | caprolactone | | | | | | |
| 11 | DPS 1 | 300 | epsilon- | 228 | DSP | 8.8 | 800 | 6 | 20 |
| | | | caprolactone | | | | | | |
| 12 | DPS 1 | 200 | delta-valero- | 228 | DSP | 8.8 | 1400 | 10 | 20 |
| | | | lactone | | | | | | |
| 13 | DPS 1 | 233 | gamma- | 173 | — | — | 700 | 6 | 20 |
| | | | butyrolactone | | | | | | |
| 14 | ATH | 200 | epsilon- | 228 | DSP | 8.8 | 1400 | 6 | 20 |
| | | | caprolactone | | | | | | |
| 15 | DPS 1 | — | — | — | — | — | — | — | — |

| | Grinding | | | | | Product | | | | |
|---|---|---|---|---|---|---|---|---|---|---|
| | Particle | | | | | | | | Melt | |
| | size | | Polymerization | | | Molar mass | | n | pump | LOI |
| | d50 | d95 | temp. | time | | Mn | Mw | Weight- | test | [% |
| Example | [μm] | [μm] | [° C.] | [h] | Process | [g/mol] | [g/mol] | average | [bar] | O₂] |
| 1 | 0.24 | 0.72 | 162 | 6 | 1 | 9711 | 16894 | 148 | 57 | 29 |
| 2 | 0.24 | 0.78 | 160 | 6 | 1 | 9231 | 16154 | 142 | 51 | 31 |
| 3 | 0.24 | 0.90 | 142 | 6 | 1 | 8731 | 14569 | 128 | 60 | 30 |
| 4 | 0.30 | 0.91 | 163 | 6 | 1 | 8250 | 14229 | 125 | 55 | 30 |
| 5 | 0.23 | 0.71 | 156 | 6 | 1 | 9212 | 16411 | 144 | 60 | 30 |
| 6 | 0.20 | 0.73 | 161 | 6 | 1 | 9234 | 16020 | 140 | 58 | 31 |
| 7 | 0.21 | 0.70 | 157 | 6 | 1 | 9221 | 16358 | 143 | 55 | 32 |
| 8 | 0.28 | 0.81 | 161 | 6 | 1 | 9350 | 16406 | 144 | 53 | 32 |
| 9 | 0.24 | 0.77 | 160 | 6 | 1 | 9162 | 16580 | 145 | 51 | 32 |
| 10 | 0.50 | 2.60 | 164 | 6 | 1 | 2776 | 6434 | 56 | 60 | 29 |
| 11 | 1.12 | 3.13 | 161 | 6 | 1 | 3428 | 6378 | 56 | 66 | 29 |
| 12 | 0.20 | 0.71 | 161 | 10 | 2 | 9121 | 14055 | 140 | 59 | 29 |
| 13 | 0.23 | 0.67 | 160 | 6 | 1 | about | about | 3 | 60 | 29 |
| | | | | | | 200 | 250 | | | |
| 14 | 0.25 | 0.84 | 161 | 6 | 1 | about | about | 2 | 72 | 20 |
| | | | | | | 230 | 250 | | | |
| 15 | — | — | — | — | — | — | — | | 130 | — |

1. A polymeric flame retardant mixture comprising
a) 0.1% to 70% by weight of dialkylphosphinic salt,
b) 0% to 20% by weight of telomers, and
c) 30% to 99.9% by weight of oligomers,
where the sum total of a), b) and c) is 100% by weight, with the proviso that a) and b) are different compounds.

2. The polymeric flame retardant mixture as claimed in claim 1, comprising
a) 2% to 50% by weight of dialkylphosphinic salt,
b) 0.1% to 10% by weight of telomers, and
c) 50% to 97.9% by weight of oligomers,
where the sum total of a), b) and c) is 100% by weight, with the proviso that a) and b) are different compounds.

3. The polymeric flame retardant mixture as claimed in claim 1, wherein the dialkylphosphinic salts are those of the formula (V) 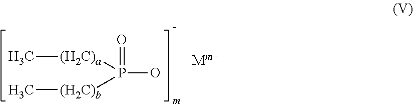
wherein
a and b are the same or different and are each independently 1 to 9, and wherein the carbon chains are linear, branched or cyclic, and
M is Mg, Ca, Al, Sb, Sn, Ge, Ti, Fe, Zr, Zn, Ce, Bi, Sr, Mn, Li, Na, K, a protonated nitrogen base or a combination thereof, and
m is 1 to 4.

4. The polymeric flame retardant mixture as claimed in claim 1, wherein a and b in formula (V) are the same or different and are each independently 1, 2 or 3.

5. The polymeric flame retardant mixture as claimed in claim 1, wherein a and b in formula (V) are the same and are each 1.

6. The polymeric flame retardant mixture as claimed in claim 3, wherein M in formula (V) is Al, Ti, Fe or Zn.

7. The polymeric flame retardant mixture as claimed in claim 1, wherein the telomers are those of the formula (VI)
H—(C_{w}H_{2w})ₖP(O)(OM)(CₓH₂ₓ)ₗ—H (VI)
wherein, in formula (VI), independently of one another,
k is 1 to 9,
l is 1 to 9,
w is 2 to 9,
x is 2 to 9,
and
M is Mg, Ca, Al, Sb, Sn, Ge, Ti, Fe, Zr, Zn, Ce, Bi, Sr, Mn, Li, Na, K, a protonated nitrogen base or a combination thereof,
and the C_{w}H_{2w})ₖ, (CₓH₂ₓ)ₗ groups are linear or branched; and/or the telomers are those of the formula (I) 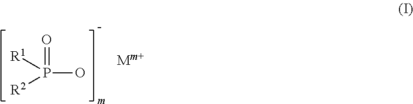
wherein
R¹, R² are the same or different and are C₆-C₁₀-arylene, C₇-C₂₀-alkylarylene, C₇-C₂₀-arylalkylene and/or C₃-C₁₆-cycloalkyl or -bicycloalkyl,
M is Mg, Ca, Al, Sb, Sn, Ge, Ti, Fe, Zr, Zn, Ce, Bi, Sr, Mn, Li, Na, K, a protonated nitrogen base or a combination thereof.

8. The polymeric flame retardant mixture as claimed in claim 7, wherein, in formula (VI),
w and x are each 2 to 4 and
k and l are each 1 to 4.

9. The polymeric flame retardant mixture as claimed in claim 7, wherein, in formula (VI),
w and x are each 2 or 3 and
k and l are each 1 to 3.

10. The polymeric flame retardant mixture as claimed in claim 7, wherein M in formula (VI), (I) or both is independently Al, Ti, Fe or Zn.

11. The polymeric flame retardant mixture as claimed in claim 1, wherein the telomers are metal salts of ethylbutylphosphinic acid, dibutylphosphinic acid, ethylhexylphosphinic acid, butylhexylphosphinic acid, ethyloctylphosphinic acid, sec-butylethylphosphinic acid, 1-ethylbutyl(butyl)phosphinic acid, ethyl(1-methylpentyl)phosphinic acid, di-sec-butylphosphinic acid (di(1-methylpropyl)phosphinic acid), propyl(hexyl)phosphinic acid, dihexylphosphinic acid, hexyl(nonyl)phosphinic acid, propyl(nonyl)phosphinic acid, dinonylphosphinic acid, dipropylphosphinic acid, butyl(octyl)phosphinic acid, hexyl(octyl)phosphinic acid, dioctylphosphinic acid, ethyl(cyclopentylethyl)phosphinic acid, butyl(cyclopentylethyl)phosphinic acid, ethyl(cyclohexylethyl)phosphinic acid, butyl(cyclohexylethyl)phosphinic acid, ethyl(phenylethyl)phosphinic acid, butyl(phenylethyl)phosphinic acid, ethyl(4-methylphenylethyl)phosphinic acid, butyl(4-methylphenylethyl)phosphinic acid, butylcyclopentylphosphinic acid, butylcyclohexylethylphosphinic acid, butylphenylphosphinic acid, ethyl(4-methylphenyl)phosphinic acid, butyl(4-methylphenyl)phosphinic acid or a combination thereof, wherein the metal in the metal salt is selected from the group consisting of Mg, Ca, Al, Sb, Sn, Ge, Ti, Fe, Zr, Zn, Ce, Bi, Sr, Mn, Li, Na, K and a combination thereof.

12. The polymeric flame retardant mixture as claimed in claim 1, wherein the oligomers are those of the formula (II)
R³—[-E-(—CR¹R²—)ₖ—(CH₂)ₗ—CO—]ₙ—OR⁴ (II)
wherein
n is 1-1 000 000,
k is 0 to 5,
l is 2 to 15,
E is O or NH,
R¹ is H,
R² is CH₃,
R³ is H, CH₃, —CO—CH(CH₃)OH or CO—C₁₋₁₀-alkyl,
R⁴ is H, CH(CH₃)CO₂H, CO—C₁₋₁₀-alkyl or
—(CH₂)ₘ—O—[CO—(CH₂)l-(CR¹R²)ₖ—)-E]ₙ—R³
wherein
m is 1-20,
R¹ is H,
R² is CH₃ and
R³ is H, CH₃ or C₁₋₁₀-alkyl.

13. The polymeric flame retardant mixture as claimed in claim 1, wherein the oligomers are those of the formula (III)
—[—N(—CO—R¹)—(CH₂)ₗ—]ₙ— (Ill)
wherein
n is 1-1 000 000,
l is 2 to 15 and
R¹ is CH₃.

14. The polymeric flame retardant mixture as claimed in claim 1, wherein the oligomers are those of the formula (IV)
—[—O—(CH₂)ₗ—CO—]ₙ— (IV)
wherein
n is 1-1 000 000, and
l is 2 to 15.

15. The polymeric flame retardant mixture as claimed in claim 1, wherein the oligomers have a molar mass of 1000 g/mol to 114*10⁶ g/mol and a chain length n of 30 to 1 000 000.

16. The polymeric flame retardant mixture as claimed in claim 1, wherein the oligomers form from lactones, lactams or a combination thereof.

17. The polymeric flame retardant mixture as claimed in claim 16, wherein the lactones are propiolactone, gamma-butyrolactone, beta-butyrolactone, delta-valerolactone, epsilon-caprolactone or a combination thereof.

18. The polymeric flame retardant mixture as claimed in claim 16, wherein the lactams are propiolactam, gamma-butyrolactam, delta-valerolactam, epsilon-caprolactam, laurolactam, methylpyrrolidin-2-one or a combination thereof.

19. The polymeric flame retardant mixture as claimed in claim 1, further comprising synergists, where the synergists are melamine phosphate, dimelamine phosphate, pentamelamine triphosphate, trimelamine diphosphate, tetrakismelamine triphosphate, hexakismelamine pentaphosphate, melamine diphosphate, melamine tetraphosphate, melamine pyrophosphate, melamine polyphosphates, melam polyphosphates, melem polyphosphates, melon polyphosphates, melamine condensation products, oligomeric esters of tris(hydroxyethyl) isocyanurate with aromatic polycarboxylic acids, benzoguanamine, tris(hydroxyethyl) isocyanurate, allantoin, glycoluril, melamine, melamine cyanurate, urea cyanurate, dicyandiamide, guanidine, nitrogen-containing phosphates of the formula (NH₄)_{y}H_{3-y}PO₄ or (NH₄PO₃)_{z} with y=1 to 3 and z=1 to 10 000, aluminum phosphites, silicates, zeolites, silicas, ceramic powder, zinc compounds, tin oxide hydrate, magnesium hydroxide, hydrotalcite, magnesium carbonate, calcium magnesium carbonate or a combination thereof.

20. The polymeric flame retardant mixture as claimed in claim 19, comprising
a) 0.1% to 70% by weight of dialkylphosphinic salt,
b) 0% to 20% by weight of telomers,
c) 30% to 99.8% by weight of oligomers, and
d) 0.1% to 30% by weight of synergists, where the sum total of a), b), c) and d) is 100% by weight, with the proviso that a) and b) are different compounds.

21. A process for producing a polymeric flame retardant mixture as claimed in claim 1, comprising the step of incorporating nanoparticulate dialkylphosphinic salt containing 0% to 20% by weight of telomers into an oligomer without the use of catalysts.

22. The process as claimed in claim 21, wherein the incorporation is effected by extruding or kneading.

23. A process for producing a polymeric flame retardant mixture as claimed in claim 1, comprising the step of wet grinding standard particulate dialkylphosphinic salt having a particle size of 0.5 to 1000 μm and containing 0% to 20% by weight of telomers in a short-chain oligomer until the particle size of 10 to 1000 μm is attained.

24. The process as claimed in claim 23, wherein attainment of the desired particle size of 10 to 1000 μm is followed by adjustment to a chain length n of 30 to 1 000 000 in a kneader.

25. The process as claimed in claim 23, wherein the reaction mixture is heated during the grinding to 20 to 160° C. for 0.1 to 72 h.

26. A fiber molding compound, film molding compound, fiber or film comprising a polymeric flame retardant mixture as claimed in claim 1.

27. A flame-retardant fiber molding compound, film molding compound, fiber or film comprising 0.1% to 80% by weight of a polymeric flame retardant mixture as claimed in claim 1 and 20% to 99.9% by weight of a thermoplastic or thermoset polymer.

28. A flame-retardant fiber molding compound, film molding compound, fiber or film comprising 0.1% to 50% by weight of a polymeric flame retardant mixture as claimed in claim 1, 50% to 99.9% by weight of a thermoplastic or thermoset polymer, 0% to 60% by weight of additives and 0% to 60% by weight of filler.

29. A flame retardant for clearcoats, intumescent coatings, wood, cellulose products, reactive flame retardants for polymers, non-reactive flame retardants for polymers, gelcoats, unsaturated polyester resins, production of flame-retardant polymer molding compounds, production of flame-retardant polymer moldings, rendering polyester and pure and blended cellulose fabrics flame-retardant by impregnation, polyurethane foams, polyolefins, unsaturated polyesters, phenolic resins or rendering textiles flame-retardant comprising a polymeric flame retardant mixture as claimed in claim 1.

30. (canceled)

31. A plug connector, current-bearing component in power distributors (residual current protection), circuit board, potting compound, power connector, circuit breaker, lamp housing, LED lamp housing, capacitor housing, coil element, ventilator, grounding contact, plug, printed circuit board, housings for plugs, cable, flexible circuit board, charging cable, motor cover or textile coating comprising a polymeric flame retardant mixture as claimed in claim 1.
